(19) United States
(12) Patent Application Publication
(10) Pub. No.: US 2015/0120236 A1
(43) Pub. Date: Apr. 30, 2015

(54) Portable device for temperature by using a mobile device such as a phone tablet or laptop

(71) Applicant: Gurpal Singh Bhoot, (US)

(72) Inventor: Gurpal Singh Bhoot, San Jose, CA (US)

(73) Assignee: SWAIVE CORPORATION, Santa Clara, CA (US)

(21) Appl. No.: 14/517,823

(22) Filed: Oct. 18, 2014

Related U.S. Application Data
(60) Provisional application No. 61/897,707, filed on Oct. 30, 2013.

(51) Int. Cl. G01K 13/00

(52) U.S. Cl. CPC G01K 13/002
USPC 702/131

(57) ABSTRACT

The portable infrared ear thermometer accessory combines a body temperature measuring tool with a mobile device to measure, store, and send the body temperature of the user. The portable infrared ear thermometer device attaches to a mobile device, wired or wirelessly, to display the body temperature of the user, which is measured through the portable infrared ear thermometer attachment. The body temperature is displayed as a digital number on the mobile device through the corresponding software application as well as on the infrared ear thermometer device. The software application shows the user their body temperature in comparison with the normal body temperature range specific to that user's age; which is found by inspecting the user's date and using algorithms to calculate this range.

### CROSS-REFERENCE TO RELATED APPLICATIONS

This application claims the benefit of PPA U.S. Ser. No. 61/897,707 filed 2013 Oct. 30 by the present inventors, which is incorporated by reference.

### BACKGROUND OF THE INVENTION

When it comes to maintaining and measuring the health of a person, the body temperature is the first measurement taken. The internal body temperature of a user helps to describe what state of health the user is in more than any other health characteristic. Therefore, an accurate temperature reading is essential in determining the health of a user. The process of getting an accurate temperature in today's society is fairly straight forward, as there are many medical devices currently available with such capabilities. These medical devices all take the user's body temperature in a variety of ways, as they can collect this information from the ear canal, anal area, armpit or even under the tongue. Most of these devices operate as an infrared device, meaning they use an infrared sensor to collect the temperature from the user. But what happens after the temperature is displayed?

The next logical step is taking your own temperature and somehow comparing it to a temperature that is considered ‘normal’. However, contrary to the popular consensus, there is no simple ‘normal’ temperature. This is somewhat more complicated to understand than looking at a number and being able to compare it to another number. The reason for this is because a person's body temperature will vary throughout the day due to the kind of activity the person may be doing. Due to these changes, normal temperature is better thought of as a range. With that in mind, the natural response is to wonder what is used to calculate or discover this temperature range that is considered to be ‘normal’. Many different body characteristics go into this calculation, including but not limited to a person's age, sex, body size. Therefore, a device that solely takes a person's instantaneous temperature really gives no benefit to the user. Another reason for this goes back to how a person's temperature changes throughout the day. So a number of readings over a certain period of time will give the user a better idea of how their temperature changes according to the particular activities they go through.

Looking at the list of needs a person would need to accurately measure their temperature, it seems like it would be hard to find such a device with all of these capabilities in today's market. What would really benefit the user is a combination of medical device, readily available that is capable of taking one's temperature and another device that is able to display and store that temperature data automatically. On top of that, a system with such characteristics as described above would be really beneficial to the user with some kind of mobile sharing option. This way the user would be able to take a temperature and remotely monitor this temperature as well as share this temperature with another individual located anywhere in the world. The invention stated in U.S. Pat. No. 8,855,757, to Rijuven Corporation is a system that acquires an electrical footprint of the heart and incorporates a mobile device accessory used for displaying and remotely monitoring this data. Such as system is desirable to the user in the sense that this medical information of the heart is readily available at all times on the mobile device accessory and transmitted easily using said device. The mobile device described in this patent can be a cellular phone, personal computer or a smartphone.

The term smartphone entails electronic devices used as a cellular phone with the capability of running software applications, such as games, utilities, web browsers, etc. The first real smartphone with these capabilities (running and loading applications) was the first generation iPhone, introduced in 2007. Since then, other cell phone companies have begun designing their own versions of smartphones. Along with software application used on the smartphone itself, there is also the ability of using separate, standalone electronic devices in connection with the smartphone through a specific software application.

A new market using the capabilities of the smartphone has emerged over the last couple of years and continues to grow exponentially. Mobile health is a category containing such hardware devices, more specifically medical devices, which are connected to the smartphone and combined with an application to build a whole new product. This includes products such as the iHealth BP3 Blood Pressure Monitor and the Withings Smart Body Analyzer.

Accordingly, the claimed invention proceeds upon the desirability of providing significant benefits to the user through the ability to track a history of temperature readings automatically and transmitting those readings to a number of persons, including but not limited to partners, parents, doctors and medical officials.

### SUMMARY OF THE INVENTION

The invention is a portable temperature measuring device that can measure, analyze, store and end the body temperature of a user. The portable device is sends the data recorded wirelessly to another mobile computerized device such as a smartphone. This mobile device is programmed to receive the data in a user-friendly style. Once this data has been received, the mobile device is able to store, display and send said data to any desired persons through a number of different transmitting methods, including but not limited to text or email messaging.

### DRAWINGS

The following detailed descriptions, given by way of example, and not intended to limit the present invention solely thereto, will be best understood with the accompanying figures.

FIG. 1 is a block diagram of the portable temperature measuring device in accordance with an exemplary embodiment of the claimed invention;

FIG. 2 further illustrates the peripherals contained in the portable temperature measuring device, more specifically the components which make up the microcontroller with an exemplary embodiment of the claimed invention.

FIG. 3. is an illustration of the components which make up the wireless interface contained in the portable temperature measuring device with an exemplary embodiment of the claimed invention.

FIG. 4. is an illustration of the user interface structures and the peripherals that are contained within with an exemplary embodiment of the claimed invention.

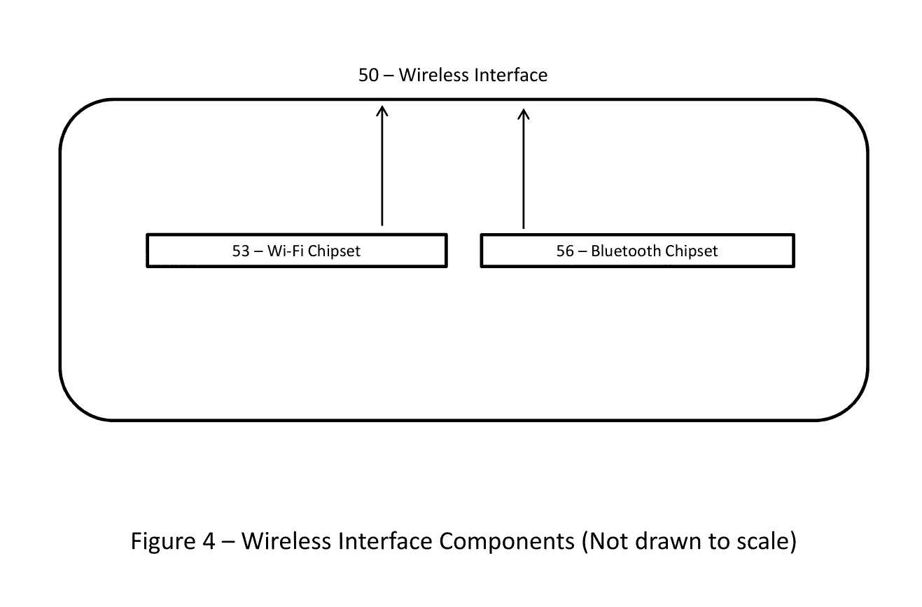

### DETAILED DESCRIPTION

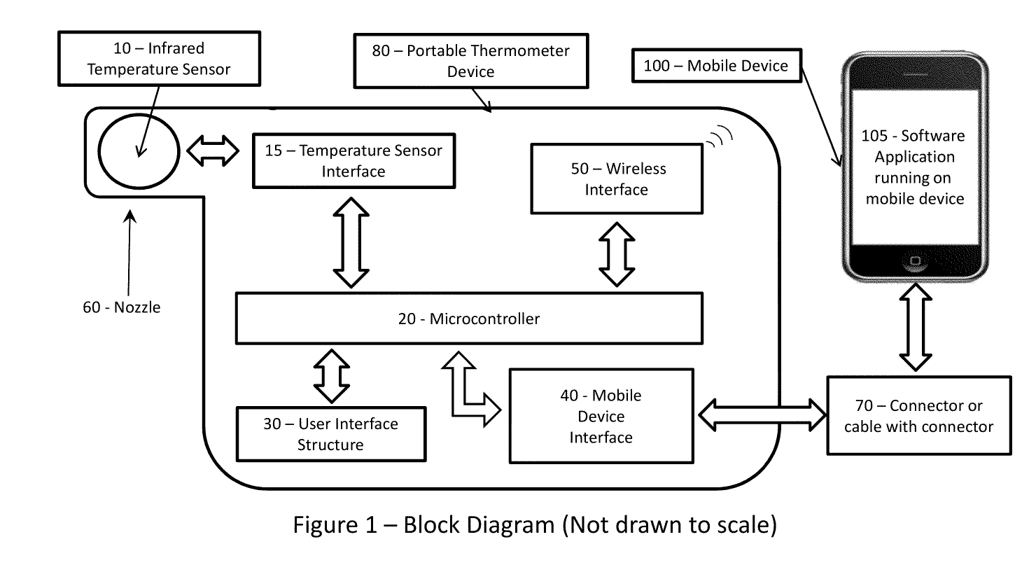

As shown in FIG. 1, in accordance with an exemplary embodiment of the claimed invention, the invention consists of two main embodiments: a portable temperature measuring device 80 and a software application 105. The portable temperature measuring device 80 contains the electronic components required to collect the body temperature of an individual. The data sent from the portable temperature measuring device 80 is transmitted to the software application 105 loaded on the mobile device 100. The user interface on the software application 105 is primarily used to display this calculated body temperature of the user.

In accordance with an exemplary embodiment of the claimed invention, the portable temperature measuring device 80 consists of a nozzle 60 which contains an infrared temperature sensor 10 at the tip. The infrared temperature sensor 10 is enclosed in a metal casing 65, which is used to maintain a consistent ambient temperature throughout the whole of said sensor. The final resulting body temperature measured is first calculated through a formula which consists of a combination of the object temperature and ambient temperature measured by the infrared temperature sensor 10. The function of the metal casing 65 allows for the change in ambient temperature to be minimal during the process of a particular temperature measurement.

The sensor provides an analog voltage and requires the temperature sensor interface 15, which amplifies the voltage, to transmit said voltage to an analog to digital converter or a microcontroller 20. The digital voltage is then converted to a format that can be accepted by a mobile device; this is implemented through a mobile device interface 40. The mobile device interface provides the connection to the mobile device; this can be a connector or a cable with a connector 70. The connector plugs directly into the mobile device 100. Alternatively, the portable temperature measuring device 80 can connect wirelessly to the mobile device through either a Bluetooth 56 or Wi-Fi chipset 53. This occurs after the microcontroller 20 determines which version the current portable temperature measuring device 80 is classified as, either the wired or wireless version. After the microcontroller 20 determines this specific portable temperature measuring device 80 is the wireless version, the mobile device interface 40 is no longer needed; therefore the microcontroller 20 communicates directly with the wireless interface 50, either Wi-Fi 53 or Bluetooth 56. Thereafter the wireless interface 50 will communicate with the application software 105, which is loaded onto the mobile device 100. Application software 105 is primarily used to display the temperature.

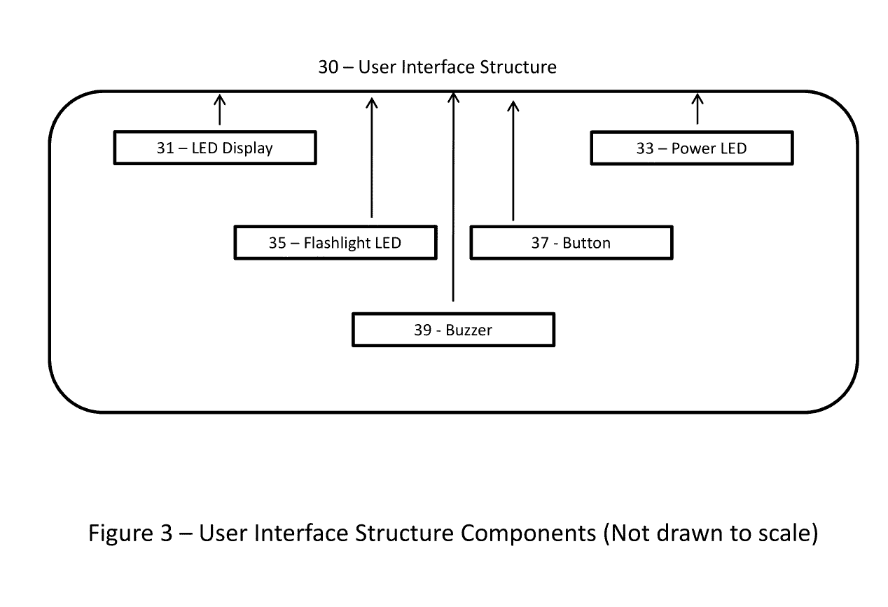

The portable temperature measuring device also comes with a unique user interface structure 30. As illustrated in FIG. 3, this user interface structure 30 consists of the following peripherals: (1) a custom-built LED display 31, (2) a power LED 33, (3) a flashlight LED 35, (4) a button 37, and (5) a buzzer 39. Each one of these components has a separate function which allows for the user to cover all areas of the temperature measurement process. The LED display 31 is built of a number of single LEDs, which put together allows for the portable temperature measuring device 80 to communicate with the user exactly which part of the temperature measurement process is currently occurring. For example, as soon as the temperature measurement process begins, the LED display 31 can show the user how many seconds remain in this process by turning on and off a certain number of LEDs to represent a single digit. Another example is after the temperature measurement process is completed; then the LED display 31 can display the converted digital temperature as digits by turning on a combination of the single LEDs to represent each digital integer of the temperature reading. The power LED 33 is used to notify the user a temperature measurement has begun. This LED can remain on throughout the temperature measurement process and turn off when the reading has been completed and the temperature has been displayed for a number of seconds. The flashlight LED 35 has a unique function to allow users to make temperature measurements in dark atmospheres. The design of the flashlight LED 35 allows for the light to be positioned directly to the desired person's ear lobe. This allows for a temperature reading to occur in dark lighting environments without the need for any external lighting, such as separate flashlights, or lamp. Other components of the user interface structure 30 include a button 37 and a buzzer 39. The buzzer 39 can be used to notify the user that a temperature measurement has begun and also when the temperature measurement process has been completed.

The process for measuring the user's temperature starts by turning on the portable temperature measuring device 80, which occurs when said device is provided with power. The portable temperature measuring device 80 can be provided with power either by inserting batteries to the wireless version or by connecting the wired version to the mobile device 100 through the connector or cable with connector 70. Once this happens, the LED display 31 from the user interface structure 30 will turn on, signaling the portable temperature measuring device 80 is ready to use. Then the user will place the nozzle 60 into the ear lobe of the desired person and press the button 37. Once this occurs, the power LED 33 will illuminate, signaling the start of temperature measurement. Until the temperature measurement has been completed, the LED display 31 will show the user how many seconds remain in the current process. Once the measurement process is completed, the buzzer 39 will make a sound notifying the user and the calculated temperature reading will be displayed on the custom-build LED display 31.

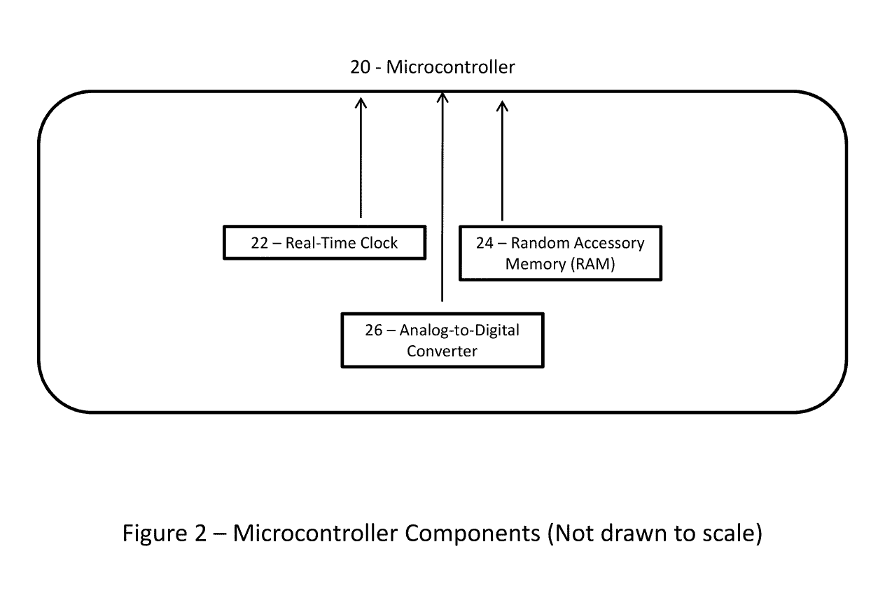

After the temperature measurement is completed, the microcontroller 20 will determine how to send the most recent temperature measurement to the mobile device 100. The microcontroller 20 first determines how the portable temperature measuring device is powered, which occurs after attempting to communicate with the mobile device interface 40. If there is no possible communication, the microcontroller assumes batteries are the source of power, therefore assuming the device is of the wireless version. As illustrated in FIG. 2, the analog-to-digital converter component 26 of the microcontroller 20 is used to read the analog voltage given off by the batteries. This process is used to determine how much battery power remains at all times and this characteristic can be used to send to the software application 105 on the mobile device 100, giving the user the ability to remotely monitor the battery level at all times from said software application 105.

Once this is determined, the microcontroller will communicate with the wireless interface 50 to determine if a possible wireless connection is put in place. If the portable temperature measuring device is already connected to the mobile device 80, the most recent temperature reading will be transmitted to the software application. If the wireless interface determines that no current connection exists, either through the Wi-Fi chipset 53 or Bluetooth chipset 56, then the microcontroller will store the temperature reading in the random access memory (RAM) 24 component. This occurs because no reading will be deleted or erased unless the user would like them to be. Also, the microcontroller 20 puts a timestamp on each reading that is kept in the RAM 24; this is done by reading the current date and time located in the real-time clock 22 component. The real-time clock 22 is first programmed through the connection between the software application 105 and the portable temperature measuring device 80, either through the wired version or the wireless version. Assuming the software application 105 contains the current date and time information, the microcontroller 20 is able to read this data through the specific connection (wired or wireless) and update the timestamp for each and every temperature measurement contained in the RAM 24. Whenever the portable temperature measuring device 80 is connected to the mobile device 100, either through the wired or wireless version, each and every one of the temperature readings contained in the RAM 24 will be transmitted to the software application 105. This allows for every one of the temperature readings taken to be tracked without missing a single one.

For the wired version, the communication is relatively the same. Immediately after the temperature measurement process is completed, the microcontroller 20 will send the current measurement to the mobile device 100 through the mobile device interface 40 and the connector or cable with connector 70 attached to the mobile device 100. In this case, there is no need to retain the current date and time from the real-time clock 22 because of the time data contained in the mobile device 100.

Once the temperature measurement is completed and the measurement data is either stored or transmitted, the portable temperature measuring device 80 will go into sleep mode, which means all peripheral components will turn on, including the components residing in the user interface structure 30. These components will remain in the sleep state until the next measurement occurs, which will be signaled when the button 37 is once again pressed.

On the application software 105, the user has the choice to keep the temperature measurement information or delete this information. If they choose to keep this information, they also have the ability to assign each and every measurement transmitted to the software application 105 to a specific individual; this allows for the user to keep a history of temperature readings specific to each member of their family, displaying the trends each individual goes through in respect to body temperature. Another feature existing within the software application 105 is the capability of sending this temperature measurement information to any desired person located anywhere in the world. The user can send this information by a number of different types of methods, including but not limited to text or email messaging. These desired persons can be partners, parents, friends, doctors or medical officials. Not only can the software application 105 send this information after being informed to do so by the user, the software application 105 comes with the capability of notifying desired persons whenever a certain individual's temperature measurement occurs. For example, a parent of a single child can allow for their partner to be subscribed to the child's member profile from the software application 105. This means once a temperature measurement has occurred and been assigned to that same child, the partner who is subscribed will be notified immediately that a temperature measurement has happened and what the specific temperature measurement data is. This allows for instantaneous monitoring of anybody's temperature from anywhere in the world. The information is transmitted through the most convenient wireless interface contained on the mobile device 100, including but not limited to cellular service or Wi-Fi.

### CONCLUSION

Accordingly, the reader will see an invention that takes advantage of the capabilities of mobile devices to display an accurate temperature measurement. The invention combines the portable temperature measuring device with the software application to produce a body temperature measuring system unique to the current market of temperature measuring devices. Furthermore, the portable temperature measuring device has the additional advantages in that:
it allows for instantaneous monitoring of an individual's body temperature from anywhere in the world;
it provides the user with ability of automatically tracking an individual's body temperature and viewing their body temperature trends;
it contains a custom-build LED display large and bright enough to read during the day or night.

Although the description above contains much specificity, these should be construed as limiting the scope of the embodiments but as merely providing illustrations of some of several embodiments. For example, the extra unique features of the

Thus the scope of the embodiments should be determined by the appended claims and their legal equivalents, rather than by the examples given.

I claim:

1. A system for displaying the body temperature of a person, comprising:
a. a portable medical device for analyzing, converting, displaying and transmitting said person's body temperature, and
b. a software application on a mobile device for receiving, displaying, recording and transmitting said person's body temperature.

2. The system of claim 1, wherein the mobile device is one of the following: a cellular phone, a smartphone, a tablet, or a personal computer.

3. The system of claim 1, wherein the portable medical device connects to a mobile device through a wireless signal, such as a wireless local area network, Bluetooth, or a cellular data service.

4. The system of claim 1, wherein the portable medical device is attached to a mobile device through a connector specific to said mobile device.

5. The system of claim 1, wherein the portable medical device is powered from the mobile device.

6. The system of claim 1, wherein the portable medical device is powered from an external power source, such as batteries.

7. The system of claim 1, wherein the portable medical device comprises of:
a. a sensor used for converting the collected body temperature of a person into a readable analog voltage, and
b. electronic components used for reading and converting said converted analog voltage into a digital temperature number, sending said digital temperature number to the mobile device in a format which said mobile device is designed to receive.

8. The portable medical device of claim 7, further comprising a metal casing, wherein said sensor is contained in order to maintain a consistent ambient temperature throughout the process of a temperature measurement, allowing for more accurate temperature readings.

9. The portable medical device of claim 7, further comprising a custom built light-emitting-diode (LED) display used for displaying said converted digital temperature number.

10. The portable medical device of claim 7, further comprising an LED used as a flashlight throughout the temperature measurement process, which is positioned to shine light unto the ear lobe in an attempt to allow for temperature readings in a dark environments without the need for any external lighting.

11. The system of claim 1, wherein the software application has the capability of assigning incoming temperature measurements, coming from the portable medical device, to any members created in the database of said software application, therefore being able to view said member's history of readings throughout a set period time.
